(19) United States
(12) Patent Application Publication
(10) Pub. No.: US 2025/0310954 A1
(43) Pub. Date: Oct. 2, 2025

(54) APPARATUS AND METHOD FOR ESTIMATING CHANNEL RELATED TO INTELLIGENT REFLECTING SURFACE IN WIRELESS COMMUNICATION SYSTEM

(71) Applicants: LG ELECTRONICS INC., Seoul (KR); KOREA ADVANCED INSTITUTE OF SCIENCE AND TECHNOLOGY, Daejeon (KR)

(72) Inventors: Jaeky OH, Seoul (KR); Junil CHOI, Daejeon (KR); Insoo KIM, Daejeon (KR); Jaehoon CHUNG, Seoul (KR)

(21) Appl. No.: 18/861,112

(22) PCT Filed: May 13, 2022
(86) PCT No.: PCT/KR2022/006900

§ 371 Date: Oct. 28, 2024

(51) Int. Cl. H04W 72/1268; H04B 7/04; H04L 5/00; H04L 25/02

(52) U.S. Cl. CPC H04W 72/1268; H04B 7/04013; H04L 5/0051; H04L 25/0224; H04L 25/0242

(57) ABSTRACT

In order to estimate a channel in a wireless communication system, a method of operating a base station may comprise receiving reference signals from at least one user equipment (UE), estimating a channel based on the reference signals, performing scheduling for uplink communication, transmitting an uplink grant to the at least one UE based on a result of scheduling, and receiving uplink data from the at least one UE according to the uplink grant,

### CROSS-REFERENCE TO RELATED APPLICATIONS

This application is a National Phase application under 35 U.S.C. 371 of International Application No. PCT/KR2022/006900, filed on May 13, 2022, the contents of which are incorporated by reference herein in their entirety.

### TECHNICAL FIELD

The following description relates to a wireless communication system, and to a device and method for estimating a channel related to an intelligent reflecting surface (IRS) in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure can provide a method and device for effectively estimating a channel in an environment using an intelligent reflecting surface (IRS) in a wireless communication system.

The present disclosure can provide a method and device for estimating a channel using active elements included in an IRS in a wireless communication system.

The present disclosure can provide a method and device for estimating a channel between at least one user equipment (UE) and an IRS in a wireless communication system.

The present disclosure can provide a method and device for estimating channels between a base station, an IRS, and at least one UE based on reception values for reference signals provided from an IRS in a wireless communication system.

The present disclosure can provide a method and device for estimating a channel based on information acquired using active elements of an IRS in a wireless communication system.

The present disclosure can provide a method and device for modeling channels as probability variables in a wireless communication system.

The present disclosure can provide a method and device for estimating a channel using a posterior distribution of a probability distribution related to channels in a wireless communication system.

The present disclosure can provide a method and device for estimating a channel based on variational inference in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method of operating a base station in a wireless communication system may comprise receiving reference signals from at least one user equipment (UE), estimating a channel based on the reference signals, performing scheduling for uplink communication, transmitting an uplink grant to the at least one UE based on a result of scheduling, and receiving uplink data from the at least one UE according to the uplink grant. The channel may be determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

As an example of the present disclosure, a base station in a wireless communication system may comprise a transceiver and a processor connected to the transceiver. The processor may receive reference signals from at least one user equipment (UE), estimate a channel based on the reference signals, perform scheduling for uplink communication, transmit an uplink grant to the at least one UE based on a result of scheduling, and receive uplink data from the at least one UE according to the uplink grant. The channel may be determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

As an example of the present disclosure, a communication apparatus may comprise at least one processor and at least one computer memory connected to the at least one processor and configured to store instructions directing operations when executed by the at least one processor. The operations may comprise receiving reference signals from at least one user equipment (UE), estimating a channel based on the reference signals, performing scheduling for uplink communication, transmitting an uplink grant to the at least one UE based on a result of scheduling, and receiving uplink data from the at least one UE according to the uplink grant. The channel may be determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

As an example of the present disclosure, a non-transitory computer-readable medium storing at least one instruction may comprise the at least one instruction executable by a processor. The at least one instruction may control a device to receive reference signals from at least one user equipment (UE), estimate a channel based on the reference signals, perform scheduling for uplink communication, transmit an uplink grant to the at least one UE based on a result of scheduling, and receive uplink data from the at least one UE according to the uplink grant. The channel may be determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

The above-described aspects of the present disclosure are only some of the preferred embodiments of the present disclosure, and various embodiments reflecting the technical features of the present disclosure can be derived and understood by a person having ordinary skill in the art based on the detailed description of the present disclosure to be described below.

As is apparent from the above description, the embodiments of the present disclosure have the following effects.

According to the present disclosure, a channel can be effectively estimated in an environment using an intelligent reflecting surface (IRS).

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates another example of a wireless device applicable to the present disclosure.

FIG. 4 illustrates an example of a hand-held device applicable to the present disclosure.

FIG. 5 illustrates an example of a car or an autonomous driving car applicable to the present disclosure.

FIG. 6 illustrates an example of an AI device applied to the present disclosure.

FIG. 7 illustrates a method of processing a transmitted signal applied to the present disclosure.

FIG. 8 illustrates an example of a communication structure providable in a 6G system applicable to the present disclosure.

FIG. 9 illustrates an electromagnetic spectrum applicable to the present disclosure.

FIG. 10 illustrates a THz communication method applicable to the present disclosure.

FIG. 11 illustrates a communication environment including an IRS according to an embodiment of the present disclosure.

FIG. 12 illustrates a relationship between observed values and hidden variables in a probability variable model according to an embodiment of the present disclosure.

FIG. 13 illustrates an example of channel estimation and communication timing according to an embodiment of the present disclosure.

FIG. 14 illustrates an example of an uplink communication procedure according to an embodiment of the present disclosure.

FIG. 15 illustrates an example of a procedure for transmitting uplink data according to an embodiment of the present disclosure.

FIG. 16 illustrates an example of a procedure for receiving uplink data according to an embodiment of the present disclosure.

FIG. 17 illustrates an example of a procedure for estimating a channel according to an embodiment of the present disclosure.

FIG. 18, FIG. 19 and FIG. 20 illustrate the performance of a channel estimation technique according to an embodiment of the present disclosure.

### MODE FOR INVENTION

Following embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment.

In the description of the drawings, procedures or steps which render the scope of the present disclosure unnecessarily ambiguous will be omitted and procedures or steps which can be understood by those skilled in the art will be omitted.

In the entire specification, when a certain portion “comprises” or “includes” a certain component, this indicates that the other components are not excluded, but may be further included unless specially described. The terms “unit”, “-or/er” and “module” described in the specification indicate a unit for processing at least one function or operation, which may be implemented by hardware, software and a combination thereof. In addition, “a or an”, “one”, “the” and similar related words may be used as the sense of including both a singular representation and a plural representation unless it is indicated in the context describing the present specification (especially in the context of the following claims) to be different from this specification or is clearly contradicted by the context.

In this specification, the embodiments of the present disclosure are described with focus on the relationship of data reception and transmission between a base station and a mobile station. Herein, the base station means a terminal node of a network that performs direct communication with the mobile station. In this document, a specific operation, which is described to be performed by a base station, may be performed by an upper node of the base station in some cases.

That is, in a network consisting of a plurality of network nodes including a base station, various operations for communicating with a mobile station may be performed by the base station or network nodes other than the base station. Herein, “base station” may be replaced by such terms as “fixed station”, “Node B”, “eNode B(eNB)”, “gNode B(gNB)”, “ng-eNB”, “advanced base station(ABS)”, or “access point”.

Also, in the embodiments of the present disclosure, “terminal” may be replaced by such terms as “user equipment(UE)”, “mobile station(MS)”, “subscriber station(SS)”, “mobile subscriber station(MSS)”, “mobile terminal” or “advanced mobile station(AMS)”.

In addition, a transmission end refers to a fixed and/or mobile node that provides a data service or a voice service, and a reception end means a fixed and/or mobile node that receives a data service or a voice service. Accordingly, in the case of an uplink, a mobile station may be a transmission end, and a base station may be a reception end. Likewise, in the case of a downlink, a mobile station may be a reception end, and a base station may be a transmission end.

The embodiments of the present disclosure may be supported by standard documents disclosed in at least one of the following radio access systems: an IEEE 802 xx system, a 3rd generation partnership project (3GPP) system, a 3GPP long term evolution (LTE) system, a 3GPP 5th generation (5G) new radio (NR) system and a 3GPP2 system, and in particular, the embodiments of the present disclosure may be supported by the following documents: 3GPP TS (technical specification) 38.211, 3GPP TS 38.212, 3GPP TS 38.213, 3GPP TS 38.321, and 3GPP TS 38.331.

In addition, the embodiments of the present disclosure are applicable to another radio access system but is not limited to the above-described system. As an example, they are applicable to a system applied after a 3GPP 5G NR system and are not limited to a specific system.

That is, obvious steps and parts not described in the embodiments of the present disclosure may be described with reference to the above documents. In addition, all the terms disclosed in this document may be explained by the standard document.

Hereinafter, a preferred embodiment according to the present disclosure will be described in detail with reference to accompanying drawings. Detailed descriptions disclosed below together with accompanying drawings are intended to describe example embodiments of the present disclosure and not intended to show any sole embodiment in which a technical configuration of the present disclosure can be implemented.

In addition, specific terms used in the embodiments of the present disclosure are provided to help understand the present disclosure, and such specific terms may be used in any other modified forms without departing from the technical idea of the present disclosure.

The following technology may be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA) and the like.

For clarity of explanation, the descriptions below are based on a 3GPP communication system (e.g. LTE, NR and the like), but the technical idea of the present disclosure is not limited thereto. LTE may mean a technology after 3GPP TS 36.xxx Release 8. Specifically, the LTE technology after 3GPP TS 36.xxx Release 10 may be referred to as LTE-A, and the one after 3GPP TS 36.xxx Release 13 may be referred to as LTE-A pro. 3GPP NR may mean a technology after TS 38.xxx Release 15. 3GPP 6G may mean a technology after TS Release 17 and/or Release 18. “xxx’ means the specific number of a standard document. LTE/NR/6G may be referred to collectively as 3GPP system.

Contents described in standard documents released earlier than the present disclosure may be referred to for the background art, terms and abbreviations used in the present disclosure. As an example, 36.xxx and 38.xxx standard documents may be referred to.

Communication system applicable to the present disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

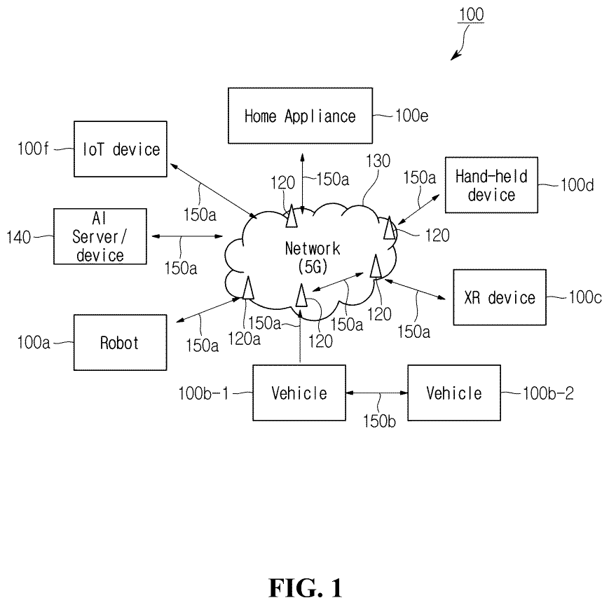

FIG. 1 illustrates an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

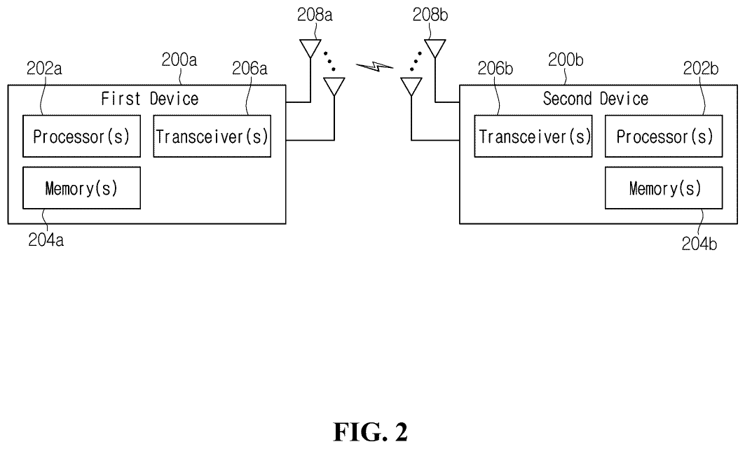

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or aplurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

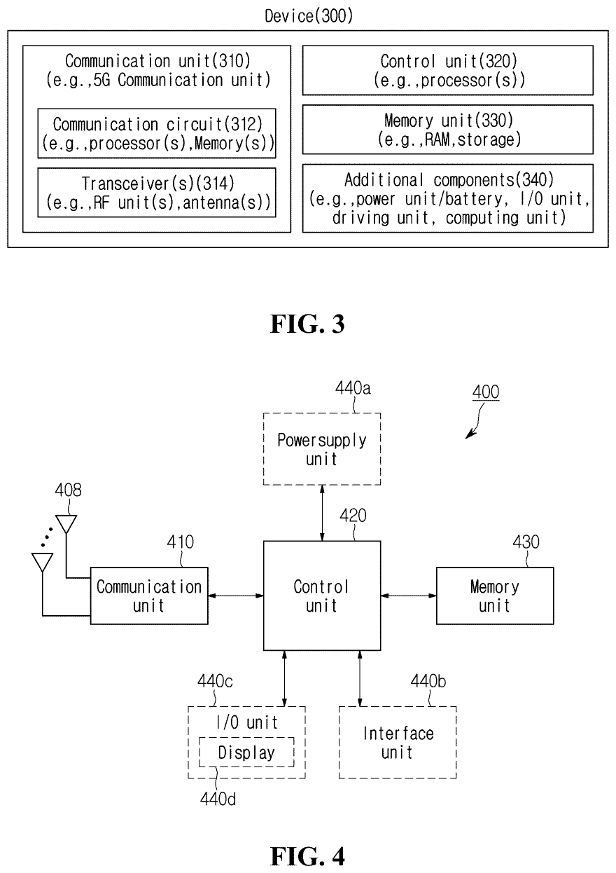

FIG. 3 illustrates another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

FIG. 4 illustrates an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

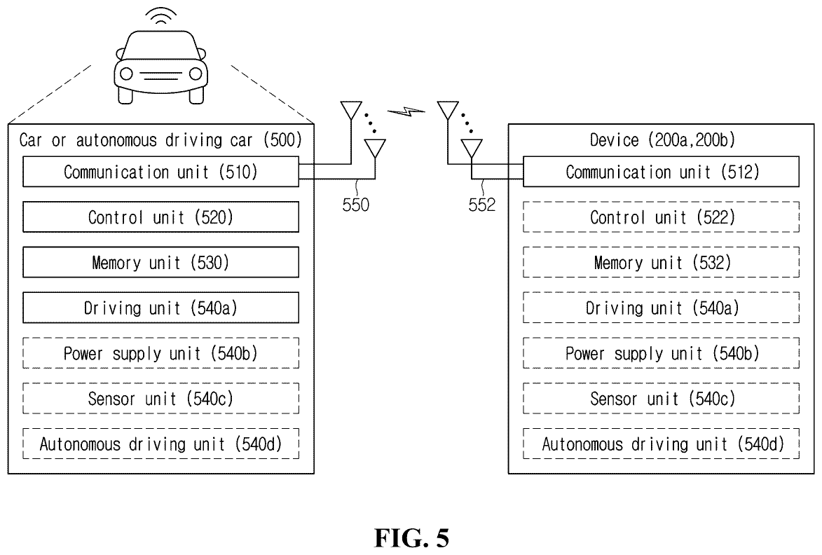

FIG. 5 illustrates an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

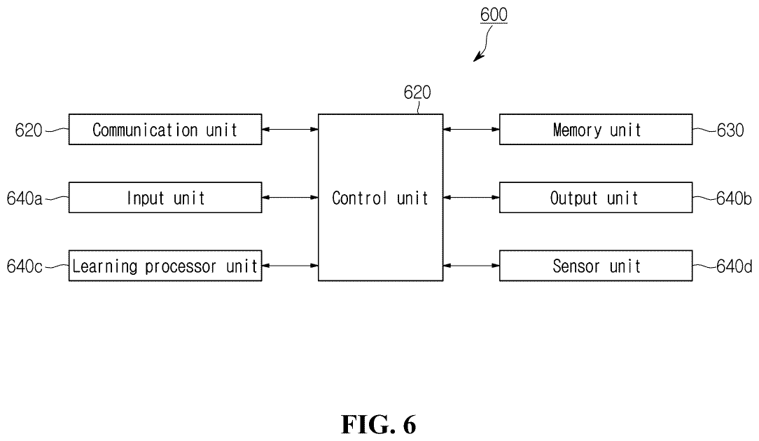

FIG. 6 illustrates an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

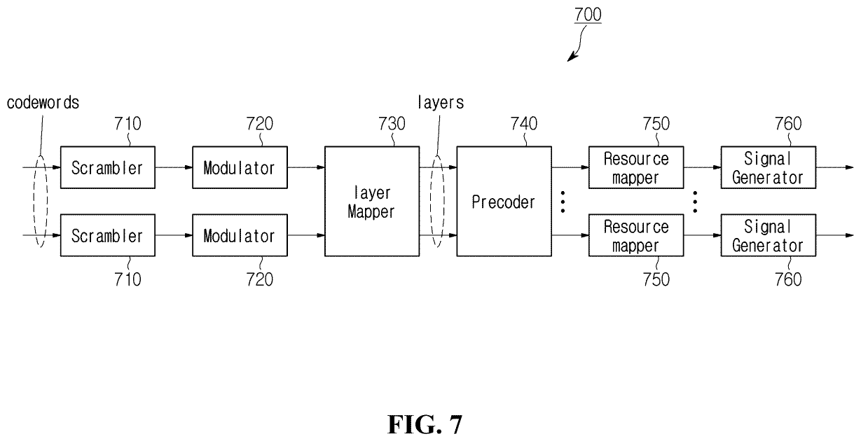

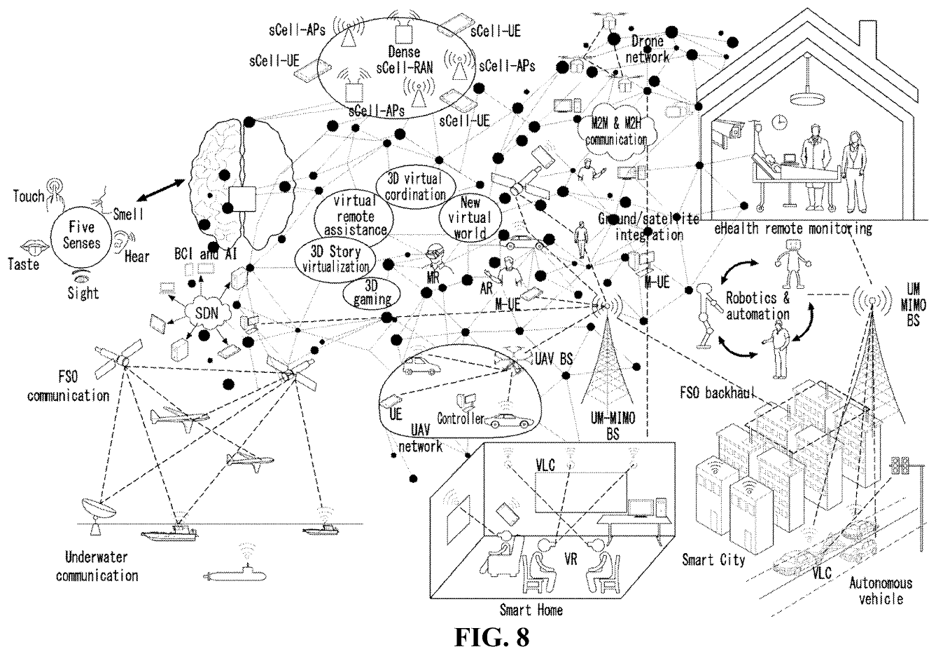

FIG. 7 illustrates a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), m-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

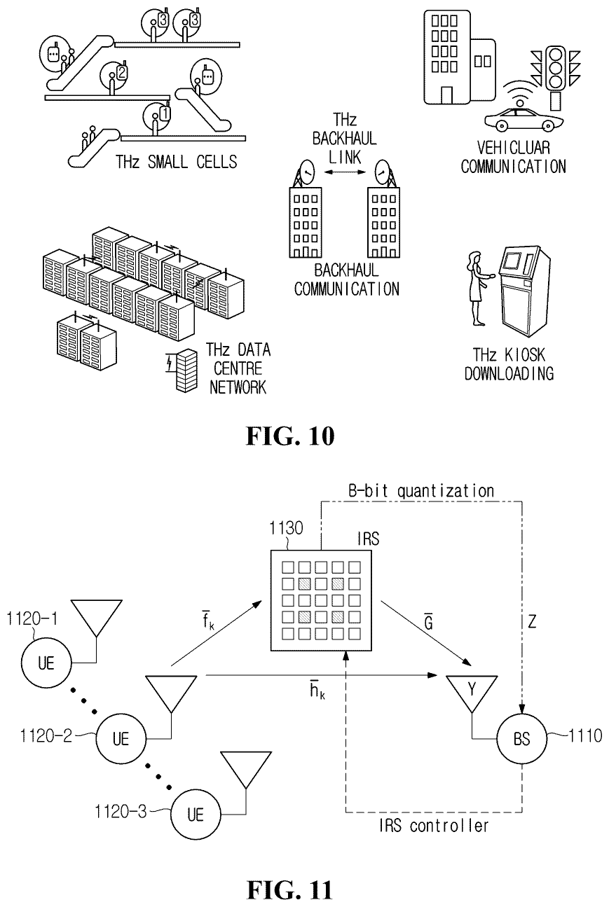

FIG. 10 illustrates an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System—Terahertz (THz) Communication

THz communication is applicable to the 6G system. For example, a data rate may increase by increasing bandwidth. This may be performed by using sub-TH communication with wide bandwidth and applying advanced massive MIMO technology.

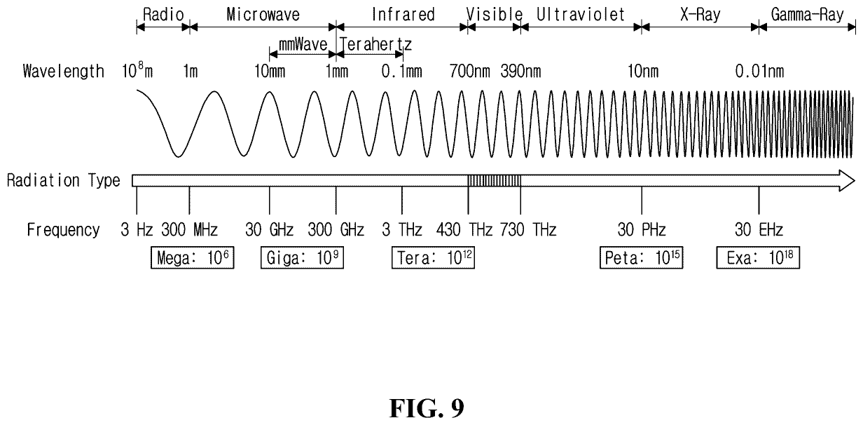

FIG. 9 illustrates an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### Thz Wireless Communication

FIG. 10 illustrates a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Intelligent Reflecting Surface (IRS)

An IRS is one of the major new technology candidates for future wireless communications, and is a surface equipped with multiple elements that reflect signals. Each element may independently change the phase of colliding electromagnetic waves. One of the main features of the IRS is that it is controllable, so that the phase change rate of each element may be adjusted in real time. Based on the adjustment of the phase change rate, it is possible to modify a wireless communication channel in real time, such as increasing an information transmission rate or assisting a device that cannot receive a signal. In addition, since it uses passive elements that only support signal reflection, the IRS may be implemented at a low price and with low power consumption.

Metamaterials, which are elements that cause signal reflection, may be implemented in various ways. For example, metamaterials may be implemented based on a diode method using metal materials, a method using liquid crystal, and a method using graphene (e.g., a method of combining graphene and metal using surface Plasmon polariton (SPP)). Metamaterials may be implemented in various ways other than these. Elements composed of metamaterials may be controlled by a controller. The controller may control each element, thereby adjusting the phase change rate applied when a signal is reflected from each element. For example, a base station or a separate device may function as a controller.

In some cases, the IRS may include active elements in addition to passive elements. The active elements are elements that have the ability to process received signals rather than simply reflecting them. The active elements may be implemented by connecting a receiving RF chain to the passive elements. Although the low cost and low complexity characteristics of the IRS, which are some of its advantages, may be weakened due to the active elements, the active elements may enable more diverse and flexible system operation. The active elements are also referred to as active sensors.

### Specific Embodiments of the Present Disclosure

The present disclosure relates to estimating a channel related to an IRS in a wireless communication system. Specifically, the present disclosure describes a technique for estimating a channel of a link between a terminal and an IRS and a link between a base station and an IRS by using at least one active element in an environment where an IRS including at least one active element is used.

The IRS may overcome high path loss of the millimeter wave band by controlling the strength and phase of the signal, and may enable communication in a shadow area by generating an additional path. The IRS is mainly composed of passive elements that operate with low power, and a base station may design a beamformer to maximize a data transmission rate by controlling the passive elements. Here, in order to efficiently operate the beamformer, it is necessary to know the channel accurately. However, if the IRS is equipped with only passive elements that cannot receive signals, accurate channel estimation may be difficult.

The IRS channel consists of a UE-IRS link, IRS-BS link, and UE-BS link. Since the passive elements do not have a signal reception capability, channel estimation in an environment using the IRS mainly considers the UE-IRS-BS link as target. However, channel estimation considering the entire UE-IRS-BS link as target is not desirable in terms of overhead. Since the dimension of the UE-IRS-BS link is very large, if the channel is estimated every time the users move, a large overhead due to the channel estimation will occur. In general, the UE-IRS link changes in a short time due to the mobility of the users, whereas the IRS-BS link is relatively fixed for a long time. Therefore, if the UE-IRS link and the IRS-BS link may be estimated separately, it is possible to significantly reduce the channel estimation overhead by re-estimating only the low-dimensional UE-IRS link when the users move. However, since the passive elements of the IRS do not have the signal reception capability, it is required to equip the IRS with at least one active element in order to estimate the UE-IRS link and the IRS-BS link, respectively. Accordingly, the present disclosure proposes a technology capable of estimating a channel based on signals received at a base station and active elements.

FIG. 11 illustrates a communication environment including an IRS according to an embodiment of the present disclosure. Referring to FIG. 11, a base station 1110 and a plurality of UEs 1120-1 to 1120-3 perform communication, and an IRS 1130 may assist signal transmission between the base station 1110 and the plurality of UEs 1120-1 to 1120-3.

Referring to FIG. 11, the base station 1110 equipped with M antennas and the UEs 1120-1 to 1120-3 equipped with a single antenna may perform uplink communication. In addition, the IRS 1130 equipped with N elements is arranged to improve communication performance between the base station 1110 and the UEs 1120-1 to 1120-3. According to various embodiments, the IRS 1130 operates as a passive element in which Nₚ elements among the N elements reflect signals, and the remaining Nₐ(=N−NₚN) active elements have the signal reception capability. The active elements may be implemented by connecting Nₐ elements among the elements of the IRS 1130 to an RF (radio frequency) chain. For example, each RF chain may include a B-bit analog to digital convertor (ADC) operating with low power.

In addition, the connection relationship between the elements of the IRS 1130 and the RF chain may be controlled by a switching network controlled by the base station 1110, and it is assumed that the switching network may be changed in real time. That is, the arrangement of the active elements is not fixed, but may be adjusted by electronic control. Accordingly, when a reference signal is transmitted during multiple transmission occasions, the arrangement of the active elements may be set for each transmission occasion. Accordingly, the arrangement of the active elements may be different in each transmission occasion.

Reference signals received at the base station 1110 from the UEs 1120-1 to 1120-3 may be expressed as in [Equation 1] below.

$$y [ t ] = \overline{G} ( \underbrace{{Ω}^{c} [ t ] ⊙ v [ t ]}_{= s [ t ]} ⊙ \overline{F} x [ t ] ) + \overline{H} x [ t ] + {n}_{B} [ t ] \qquad [ Equation 1 ]$$

In [Equation 1], y[t] denotes a reception value at the base station for reference signals at a transmission occasion t, G̅ denotes the channel between the IRS and the base station, Ω^{c}[t] denotes the positions of the passive elements among the elements of the IRS at transmission occasion t, ⊙ denotes a Hadamard product operator, v[t] denotes the reflection coefficient values set for the passive elements of the IRS at transmission occasion t, s[t] denotes the position information of the IRS passive elements multiplied by the reflection coefficient, F̅ denotes the channel between the UEs and the base station, x[t] denotes the reference signals at transmission occasion t, H̅ denotes the channel between the UEs and the base station, and nB[t] denotes noise received at the base station at transmission occasion t.

The reception values for the reference signals received by the Nₐ active elements provided in the IRS 1130 are quantized. In order to inform the base station 1110 of the reception values for the reference signals in the IRS 1130, the quantized results may be transmitted as control information through a separate link between the IRS 1130 and the base station 1110. The quantized results may be expressed as in [Equation 2] below.

$$\hat{z} [ t ] = Q ( u [ t ] ) = Q ( Ω [ t ] ⊙ \overline{F} x [ t ] + {n}_{I} [ t ] ) \qquad [ Equation 2 ]$$

In [Equation 2], \hat{z}[t] denotes the quantization result of the reception value in the IRS for the reference signals at the transmission occasion t, Q(⋅) denotes a quantization function, u[t] denotes the reception value in the IRS for the reference signals at the transmission occasion t, Ω[t] denotes the position of the active elements among the elements of the IRS at the transmission occasion t, F̅ denotes the channel between the UEs and the base station, x[t] denotes the reference signals at the transmission occasion t, and n_{I}[t] denotes noise received at the IRS at the transmission occasion t. In [Equation 2], Q(⋅) has the following input-output relationship as shown in [Equation 3].

$${\hat{z}}_{n} [ t ] = Q ( {u}_{n} [ t ] ) ↔ \{ \begin{matrix}Re ( {\hat{z}}_{n}^{lo} [ t ] ) \leq Re ( {u}_{n} [ t ] ) < Re ( {\hat{z}}_{n}^{up} [ t ] ) \\ Im ( {\hat{z}}_{n}^{lo} [ t ] ) \leq Im ( {u}_{n} [ t ] ) < Im ( {\hat{z}}_{n}^{up} [ t ] )\end{matrix} \qquad [ Equation 3 ]$$

In [Equation 3], \hat{z}ₙ[t] denotes the output of the quantization function, Q(⋅) denotes the quantization function, uₙ[t] denotes the input of the quantization function, \hat{z}ₙ^{lo}[t] denotes the lower bounds of the quantization, and, \hat{z}ₙ^{up}[t] denotes the upper bounds of the quantization.

\hat{z}ₙ^{lo}[t] and \hat{z}ₙ^{up}[t] represent the quantization intervals corresponding to \hat{z}ₙ[t]. That is, each of the real parts of \hat{z}ₙ^{lo}[t], \hat{z}ₙ[t] and \hat{z}ₙ^{up}[t] correspond to one of {−∞, −(2^{B-1}-1)Δ, −(2^{B-1}-2)Δ, . . . (2^{B-1}-1)Δ}, {−(2^{B-1}-0.5)Δ, −(2^{B-1}-1.5)Δ, −(2^{B-1}-2.5)Δ, . . . , (2^{B-1}-0.5)Δ} and {−(2^{B-1}-1)Δ, . . . , (2^{B-1}-1)Δ,∞}, and the same goes for the imaginary parts. Here, Δ is a value that determines the size of the quantization interval, and is mainly set to E{∥u[t]∥²}/(2N). Here, E{∥u[t]∥²} may depend on the characteristics of the AGC (automatic gain controller) equipped in the active element of the IRS.

The signals received at the base station 1110 and the IRS 1130 corresponding to T reference signals may be expressed as in [Equation 4] below.

$$Y = [ y [ 1 ] … y [ T ] ] = \overline{G} ( S ⊙ \overline{F} X ) + \overline{H} X + {N}_{B} \qquad [ Equation 4 ]$$

$$\hat{Z} = [ \hat{z} [ 1 ] … \hat{z} [ T ] ] = Q ( U ) = Q ( Ω ⊙ \overline{F} X + {N}_{I} )$$

In [Equation 4], Y denotes the reception signal value at the base station for the reference signals transmitted during T transmission occasions, y[t] denotes the reception signal value at the base station for the reference signals transmitted at the t-th transmission occasion, G̅ denotes the channel between the IRS and the base station, S denotes the position information of the IRS passive elements multiplied by the reflection coefficient during T transmission occasions, ⊙ denotes a Hadamard product operator, F̅ denotes the channel between the UEs and the base station, X denotes the reference signals transmitted during T transmission occasions, H̅ denotes the channel between the UEs and the base station, NB denotes noise received at the base station during T transmission occasions, \hat{Z} denotes the quantization result of the reception value at the IRS for the reference signals transmitted during T transmission occasions, \hat{z}[t] denotes the quantization result of the reception value at the IRS for the reference signals at transmission occasion t, Q(⋅) denotes a quantization function, U denotes the reception value at the IRS for the reference signals during T transmission occasions, Ω denotes the position of the active elements among the elements of the IRS during T transmission occasions, F̅ denotes the channel between the UEs and the base station, and N_{I} denotes noise received at the IRS during T transmission occasions.

According to various embodiments, F̅, G̅, and H̅ used to express the channel of [Equation 4] may be estimated from the reception signals (e.g., Y and \hat{Z}) for the reference signals. Specifically, according to various embodiments, considering the situation in which communication is performed in the millimeter wave band, it is possible to apply Bayesian channel estimation after transforming the matrices F̅, G̅ and H̅ into sparse matrices.

The channel may be transformed into a sparse matrix by virtual channel transformation. The virtual channel transformation is as shown in [Equation 5] below.

$$\overline{F} = {A}_{I} F , \qquad [ Equation 5 ]$$

$$\overline{G} = {A}_{B} G {A}_{I}^{H} ,$$

$$\overline{H} = {A}_{B} H$$

In [Equation 5], F̅ denotes the channel between the UEs and the base station, A_{I} denotes a matrix with a size of N×N_{g} and is a kernel matrix for virtual channel transformation, F denotes the sparse matrix corresponding to F̅, G̅ denotes the channel between the IRS and the base station, AB denotes a matrix with a size of M×M_{g} and is a kernel matrix for virtual channel transformation, G denotes the sparse matrix corresponding to G̅, H̅ denotes the channel between the UEs and the base stations, and H denotes the sparse matrix corresponding to H̅.

In the present disclosure, M_{g} and N_{g} are set to M and N, A_{B} may be set to a discrete Fourier transform matrix with a size of M×M such as DFT_{M}, and A_{I} may be set to a discrete Fourier transform matrix with a size of M×N such as DFT_{N}. In the case of the millimeter wave band, since F, G, and H may be regarded as sparse matrices, the reception signals may be expressed as in [Equation 6] below using virtual channel transformation.

$$Y = {A}_{B} G {A}_{I}^{H} ( S ⊙ {A}_{I} F X ) + {A}_{B} H X + {N}_{B} \qquad [ Equation 6 ]$$

$$\hat{Z} = Q ( U ) = Q ( Ω ⊙ {A}_{I} F X + {N}_{I} )$$

In [Equation 6], Y denotes the reception signal value at the base station for the reference signals transmitted during T transmission occasions, A_{B} denotes the kernel matrix for virtual channel transformation, G denotes the sparse matrix corresponding to the channel between the IRS and the base station, A_{I} denotes the kernel matrix for virtual channel transformation, S denotes the position information of the IRS passive elements multiplied by the reflection coefficient during T transmission occasions, ⊙ denotes a Hadamard product operator, F denotes a sparse matrix corresponding to the channel between the UEs and the base station, X denotes the reference signals transmitted during T transmission occasions, N_{B} denotes noise received at the base station during T transmission occasions, \hat{Z} denotes the quantization result of the reception value at the IRS for the reference signals transmitted during T transmission occasions, Q(⋅) denotes a quantization function, U denotes the reception value at the IRS for the reference signals during T transmission occasions, Ω denotes the positions of the active elements among the elements of the IRS during T transmission occasions, and N₁ denotes noise received at the IRS during T transmission occasions.

In order to estimate F, G, and H from Y and \hat{Z}, the present disclosure proposes a minimum mean square error (MMSE) channel estimation technique using a Bayesian inference technique that determines the posterior distribution by treating F, G, and H as probability variables, and then determines the posterior mean of each of F, G, and H.

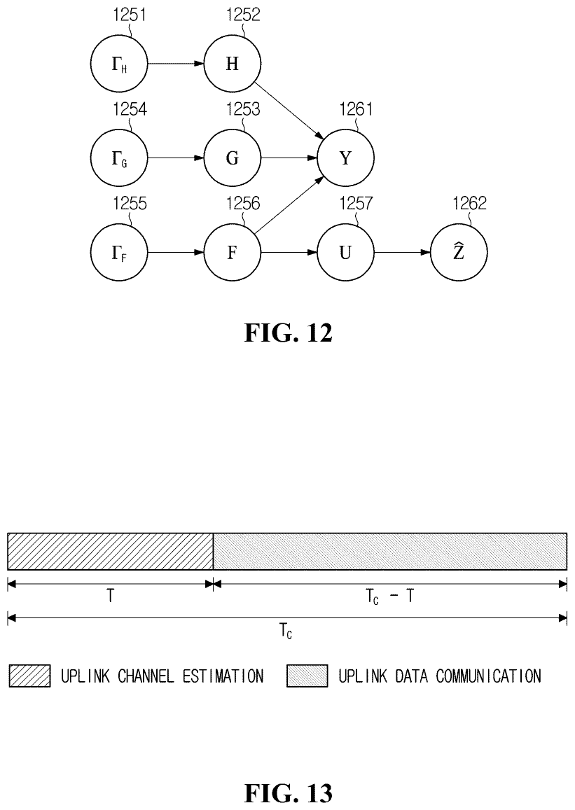

In the present disclosure, in order to model F, G, and H as probability variables having the characteristics of a sparse matrix, probability variables Γ_{F}∈ [symbol] ^{N}^{_{A}}^{×K}, Γ_{G}∈ [symbol] ^{M}^{_{g}}^{×N}^{_{g}} and Γ_{H}∈ [symbol] ^{M}^{_{g}}^{×}K are introduced. At this time, the values [symbol] that the base station may observe and the hidden variables [symbol] that cannot be observed may be expressed as {Y,\hat{Z}} and {F,G,H,Γ_{F},Γ_{G},Γ_{H},U}, respectively. The relationship between { [symbol] , [symbol] } is expressed from the viewpoint of conditional probability as shown in FIG. 12.

FIG. 12 illustrates a relationship between observed values and hidden variables in a probability variable model according to an embodiment of the present disclosure. Referring to FIG. 12, a hidden variable H 1552 is derived from a hidden variable Γ_{F} 1251, a hidden variable G 1254 is derived from a hidden variable Γ_{G} 1253, a hidden variable F 1256 is derived from a hidden variable Γ_{H} 1255, and a hidden variable U 1257 is derived from a hidden variable F 1256. In addition, an observable value Y 1261 is derived from the hidden variable H 1552, the hidden variable G 1254, and the hidden variable F 1256, and an observable value \hat{Z} is derived from the hidden variable U 1257.

More specifically, { [symbol] , [symbol] } may be expressed as a conditional probability relationship. To this end, it may be expressed as [symbol] ={y,\hat{z}} and [symbol] ={f,g,h,γ_{f},γ_{E},γₕ,u} by vectorizing the matrices included in { [symbol] , [symbol] }. For example, f=vec(F), \hat{z}=vec(\hat{Z}), \hat{z}^{lo}=vec(\hat{Z}^{lo}) \hat{z}^{up}=vec(\hat{Z}^{up}). The conditional probabilities expressing the relationship of FIG. 12 may be summarized as in [Equation 7] below.

$$p ( f \vert {γ}_{f} ) = ( f \vert 0 , {Γ}_{f}^{- 1} ) \qquad [ Equation 7 ]$$

$$p ( g \vert {γ}_{g} ) = ( g \vert 0 , {Γ}_{g}^{- 1} )$$

$$p ( h \vert {γ}_{h} ) = ( h \vert 0 , {Γ}_{h}^{- 1} )$$

$$p ( {γ}_{f} ) = {\prod }_{i} Gamma ( {γ}_{f , i} \vert a , b )$$

$$p ( {γ}_{g} ) = {\prod }_{i} Gamma ( {γ}_{g , i} \vert a , b )$$

$$p ( {γ}_{h} ) = {\prod }_{i} Gamma ( {γ}_{h , i} \vert a , b )$$

$$p ( y \vert f , g , h ) = ( y \vert vec ( {A}_{B} G {A}_{I}^{H} ( S ⊙ {A}_{I} F X ) + {A}_{B} H X ) , {σ}_{B}^{2} I ) ,$$

$$p ( u \vert f ) = ( u \vert vec ( Ω ⊙ {A}_{I} FX ) , {σ}_{I}^{2} I )$$

$$p ( \hat{z} \vert u ) = 𝕀 ( \hat{z} = Q ( u ) )$$

$$= 𝕀 ( Re ( {\hat{z}}^{lo} ) ⪯ Re ( u ) ≺ Re ( {\hat{z}}^{up} ) ) \cdot 𝕀 ( Im ( {\hat{z}}^{lo} ) ⪯ Im ( u ) ≺ Im ( {\hat{z}}^{up} ) )$$

In [Equation 7], f denotes a vector obtained by vectorizing the sparse matrix corresponding to the channel between the UEs and the IRS, γ_{f} denotes a vector obtained by vectorizing a probability variable corresponding to the channel between the UEs and the IRS, Γ_{f} denotes a matrix having as a diagonal element, g denotes a vector obtained by vectorizing the sparse matrix corresponding to the channel between the IRS and the base station, γ_{g} denotes a vector obtained by vectorizing a probability variable corresponding to the channel between the IRS and the base station, Γ_{g} denotes a matrix having γ_{g} as a diagonal element, h denotes a vector obtained by vectorizing the sparse matrix corresponding to the channel between the UEs and the base station, γₕ denotes a vector obtained by vectorizing a probability variable corresponding to the channel between the UEs and the base station, Γₕ denotes a matrix having as a diagonal element, [symbol] (x|m,c) denotes a Gaussian probability distribution function having a mean m and a covariance matrix c, Gamma(x|a,b) denotes a gamma probability distribution function having a and b as hyperparameters, defined as

$$\frac{{b}^{a}}{Γ ( a )} {x}^{a \cdot 1} {e}^{- bx} ,$$

vec( ) denotes a vectorization operator, y denotes a reception at a base station for reference signals, vec( ) denotes a vectorization operator, A_{B} and A_{BI} denote kernel matrices for virtual channel transformation, G denotes a sparse matrix corresponding to the channel between the IRS and the base station, S denotes the position information of the IRS passive elements multiplied by the reflection coefficient, F denotes a sparse matrix corresponding to the channel between the UEs and the base station, X denotes the transmission value of the reference signals, H denotes a sparse matrix corresponding to the channel between the UEs and the base station, σB² denotes noise received at the base station, u denotes a vector obtained by vectorizing the reception values at the IRS for the reference signals, Ω denotes the positions of the active elements among the elements of the IRS, σI² denotes noise received at the IRS, \hat{Z} denotes the quantization result of the reception values in the IRS for the reference signals, \hat{z}ₙ^{lo} denotes the lower bound of the quantization, and \hat{z}ₙ^{up} denotes the upper bound of the quantization.

In [Equation 7], it is defined as Γ_{f}=diag(γ_{f}), Γ_{g}=diag(γ_{g}) and Γₕdiag(γₕ). In addition, by setting the posterior distribution of {f,g,h} to Gaussian-gamma distribution, {f,g,h}may become a sparse vector. In addition, a and b, which determine the gamma probability distribution, are hyperparameters and may be set to a=b=10⁻⁶.

Based on the probability distribution model expressed as described above, variational inference (VI)-based posterior distribution estimation may be performed to obtain channel information. The variational inference technique searches for the probability distribution q( [symbol] )=Πᵢq( [symbol] ᵢ) that is closest to the actual posterior distribution p( [symbol] | [symbol] ) in terms of the Kullback-Leibler (KL) divergence, as shown in [Equation 8] below.

$$q ( {𝒳}_{i} ) ∝ exp \{ \underbrace{{𝔼}_{{\prod }_{j \neq i} q ( {𝒳}_{j} )} \{ log p ( 𝒳 , 𝒴 ) \}}_{= 〈 log p ( 𝒳 , 𝒴 ) 〉 {x}_{i}} \} for ∀ i \qquad [ Equation 8 ]$$

In [Equation 8], q( [symbol] ᵢ) denotes the posterior distribution of the i-th hidden variable, p( [symbol] , [symbol] ) denotes p( [symbol] | [symbol] ⁻)p( [symbol] ), which is the product of nine probability distributions defined in [Equation 7], <⋅>xᵢ denotes the mean value for Π_{j≠i}q( [symbol] ⱼ), and <⋅> denotes the mean value for q( [symbol] ).

When [Equation 7] is substituted into [Equation 8], channel estimation techniques according to various embodiments are derived. The channel estimation algorithm according to various embodiments may be referred to as a VI-sparse Bayesian learning (SBL) channel estimation algorithm. The VI-SBL channel estimation algorithm is summarized in [Table 2] below.

TABLE 2
Algorithm VI-SBL-based channel estimator

| Input: y ∈ [symbol] ^{MT}, \hat{z} ∈ [symbol] ^{NT}, \hat{z}^{lo} ∈ [symbol] ^{NT}, \hat{z}^{up} ∈ [symbol] ^{NT}, Ω ∈ {0, 1]^{N×T}, X ∈ | |
|---|---|
| | [symbol] ^{K×T}, S ∈ [symbol] ^{N×T}, A_{B} = DFT_{M} ∈ [symbol] ^{M×M}, A_{I} = DFT_{N} ∈ [symbol] ^{N×N}, σ_{B}², σ_{I}² |
| | Output: \hat{F̅}, \hat{G̅}, \hat{H̅} |
| 1: | // Initialization |
| 2: | a = 10⁻⁶ and b = 10⁻⁶ |
| 3: | m_{f} = 0_{N}_{_{g}}_{K}_{, C}_{_{f}} = I_{N}_{_{g}}_{K}_{; m}_{ₕ} = 0_{M}_{_{g}}_{K}_{, C}_{ₕ} = I_{M}_{_{g}}_{K}_{,} [symbol] γ_{_{f}} [symbol] = I_{_{N}}_{_{g}}_{K}_{;} [symbol] γ_{_{g}} [symbol] = |
| | I_{M}_{_{g}}_{N}_{_{g}}, [symbol] γₕ [symbol] = I_{M}_{_{g}}_{K} and [symbol] u [symbol] = \hat{z} |
| 4: | while termination condition do |
| 5: | Update m_{g} and C_{g} |
| 6: | Update [symbol] γ_{g} [symbol] |
| 7: | Update mₕ and Cₕ |
| 8: | Update [symbol] γₕ [symbol] |
| 9: | Update m_{f} and C_{f} |
| 10: | Update [symbol] γ_{f} [symbol] |
| 11: | Update [symbol] u [symbol] |
| 12: | end while |
| 13: | \hat{F̅} = A_{I}reshape(m_{f}, [N_{g}, K]) |
| 14: | \hat{G̅} = A_{B}reshape(m_{g}, [M_{g}, N_{g}]) A_{I}^{H} |
| 15: | \hat{H̅} = A_{B}reshape(mₕ, [M_{g}, K]) |

In the algorithm of [Table 2], y denotes the reception value at the base station for the reference signals, M denotes the number of antennas of the base station, T denotes the number of transmission occasions of the reference signal, N denotes the number of elements of the IRS, K denotes the number of UEs, N_{g} and M_{g} denote parameters specifying the size of the channel matrix, m_{f} and C_{f} denote the mean and covariance matrices of the posterior distribution of the vector obtained by vectorizing the sparse matrix corresponding to the channel between the UEs and the IRS, mₕ and Cₕ denote the mean and covariance matrices of the posterior distribution of the vector obtained by vectorizing the sparse matrix corresponding to the channel between the UEs and the base station, m_{g} and C_{g} denote the mean and covariance matrices of the posterior distribution of the vector obtained by vectorizing the sparse matrix corresponding to the channel between the IRS and the base station, \hat{z} denotes the quantization result of the reception value at the IRS for the reference signals, \hat{z}ₙ^{lo} denotes the lower bound of the quantization, \hat{z}ₙ^{up} denotes the upper bound of the quantization, Ω denotes the positions of the active elements among the elements of the IRS, X denotes the transmission value of the reference signal, and S denotes the position of the IRS passive elements multiplied by the reflection coefficient, A_{B} and A_{I} denote kernel matrices for virtual channel transformation, σB² and σI² denote noise levels, [symbol] denotes the estimation result of the channel between the UEs and the IRS, [symbol] denotes the estimation result of the channel between the IRS and the base station, [symbol] denotes the estimation result of the channel between the UEs and the base station, reshape(x,[m,n]) denotes an operator that transforms the vector x into a matrix with a size of m×n. The above-mentioned variable definitions are also applied to [Equation 9] to [Equation 22] below.

That is, according to the VI-SBL algorithm, the base station may perform channel estimation based on the received reference signals Y and the reference signals received from the active elements of the IRS, and determine the estimated values (e.g., [symbol] =Aᵢreshape(m_{f},[N_{g},K]) [symbol] =A_{B}reshape(m_{g},[M_{g},N_{g}])A_{I}^{H}, [symbol] =A_{B}reshape(mₕ,[Mₕ,K])) of the UE-IRS link, the IRS-BS link, and the UE-BS link. Referring to [Equation 9] to [Equation 22] below, the algorithm of [Table 2] is explained as follows.

First, as in row 5 of [Table 2], m_{g} and C_{g} are updated. The variables used for updating m_{g} and C_{g} are as shown in [Equation 9] below.

$$\begin{matrix}{B}_{g} = diag ( vec ( S ) ) ( {X}^{T} ⊗ {A}_{I} ) \\ {[ {C}_{g g} ]}_{i , j} = {{\sum }_{k = 1}^{T} [ {B}_{g} ( {C}_{f} + {m}_{f} {m}_{f}^{H} ) {B}_{g}^{H} ]}_{i + ( k - 1 ) N , j + ( k - 1 ) N} ( i = 1 , … , N , j = 1 , … , N ) \\ 〈 F 〉 = reshape ( {m}_{f} , [ {N}_{g} , K ] ) \\ 〈 {A}_{g f} 〉 = ( {S}^{T} ⊙ {X}^{T} {〈 F 〉}^{T} {A}_{I}^{T} ) {A}_{I}^{*} ⊗ {A}_{B} \\ 〈 {b}_{g h} 〉 = ( {X}^{T} ⊗ {A}_{B} ) {m}_{h} \\ 〈 {A}_{g f}^{H} {A}_{g f} 〉 = {A}_{I}^{T} {C}_{g g} {A}_{I}^{*} ⊗ {A}_{B}^{H} {A}_{B} \\ 〈 {Γ}_{f} 〉 = reshape ( 〈 {γ}_{f} 〉 , [ {N}_{g} , K ] )\end{matrix} \qquad [ Equation 9 ]$$

The update of m_{g} and C_{g} in row 5 of [Table 2] may be performed as in [Equation 10] below.

$$\begin{matrix}{m}_{g} = {C}_{g} ( \frac{1}{{σ}_{B}^{2}} {〈 {A}_{g f} 〉}^{H} ( y - 〈 {b}_{g h} 〉 ) ) \\ {C}_{g} = {( \frac{1}{{σ}_{B}^{2}} 〈 {A}_{g f}^{H} {A}_{g f} 〉 + 〈 {Γ}_{g} 〉 )}^{- 1}\end{matrix} \qquad [ Equation 10 ]$$

The variables used for updating <γ_{g}> in row 6 of [Table 2] are as shown in [Equation 11] below.

$$\begin{matrix}\overline{a} = a + 1 \\ {\overline{b}}_{g , i} = b + {[ {C}_{g} + {m}_{g} {m}_{g}^{H} ]}_{i , i} ( i = 1 , … , {M}_{g} {N}_{g} )\end{matrix} \qquad [ Equation 11 ]$$

The update of <γ_{g}> in row 6 of [Table 2] may be performed as in [Equation 12] below.

$$〈 {γ}_{g , i} 〉 = \frac{\overline{a}}{{\overline{b}}_{g , i}} ( i = 1 , … , {M}_{g} {N}_{g} ) \qquad [ Equation 12 ]$$

The variables used for updating mₕ and Cₕ in row 7 of [Table 2] are as shown in [Equation 13] below.

$$\begin{matrix}〈 F 〉 = reshape ( {m}_{f} , [ {N}_{g} , K ] ) \\ {A}_{h} = {X}^{T} ⊗ {A}_{B} \\ 〈 {b}_{h f g} 〉 = ( ( {S}^{T} ⊙ {X}^{T} {〈 F 〉}^{T} {A}_{I}^{T} ) {A}_{I}^{*} ⊗ {A}_{B} ) {m}_{g} \\ 〈 {Γ}_{h} 〉 = reshape ( 〈 {γ}_{h} 〉 , [ {M}_{g} , K ] )\end{matrix} \qquad [ Equation 13 ]$$

The update of mₕ and Cₕ in row 7 of [Table 2] may be performed as in [Equation 14] below.

$$\begin{matrix}{m}_{h} = {C}_{h} ( \frac{1}{{σ}_{B}^{2}} {A}_{h}^{H} ( y - 〈 {b}_{h f g} 〉 ) ) \\ {C}_{h} = {( \frac{1}{{σ}_{B}^{2}} {A}_{h}^{H} {A}_{h} + 〈 {Γ}_{h} 〉 )}^{- 1}\end{matrix} \qquad [ Equation 14 ]$$

The variables used for updating <γₕ> in row 8 of [Table 2] are as shown in [Equation 15] below.

$$\begin{matrix}\overline{a} = a + 1 \\ {\overline{b}}_{h , i} = b + {[ {C}_{h} + {m}_{h} {m}_{h}^{H} ]}_{i , i} ( i = 1 , … , {M}_{g} K )\end{matrix} \qquad [ Equation 15 ]$$

The update of <γₕ> in row 8 of [Table 2] may be performed as in [Equation 16] below.

$$〈 {γ}_{h , i} 〉 = \frac{\overline{a}}{{\overline{b}}_{h , i}} ( i = 1 , … , {M}_{g} K ) \qquad [ Equation 16 ]$$

The variables used for updating m_{f} and C_{f} in row 9 of [Table 2] are as shown in [Equation 17] below.

$$\begin{matrix}〈 G 〉 = reshape ( {m}_{g} , [ {M}_{g} , {N}_{g} ] ) \\ {B}_{f} = diag ( vec ( S ) ) ( {X}^{T} ⊗ {A}_{I} ) \\ {C}_{ff} = reshape ( col 2 {im ( {C}_{g} + {m}_{g} {m}_{g}^{H} , [ {M}_{g} , {N}_{g} ] , [ {M}_{g}^{2} , {N}_{g}^{2} ] )}^{H} v e c ( {A}_{B}^{H} {A}_{B} ) , [ {N}_{g} , {N}_{g} ] ) \\ 〈 {A}_{f g} 〉 = ( {I}_{T} ⊗ {A}_{B} 〈 G 〉 {A}_{I}^{H} ) diag ( vec ( S ) ) ( {X}^{T} ⊗ {A}_{I} ) \\ 〈 {b}_{f h} 〉 = ( {X}^{T} ⊗ {A}_{B} ) {m}_{h} \\ {A}_{f} = diag ( vec ( Ω ) ) ( {X}^{T} ⊗ {A}_{I} ) \\ 〈 {A}_{fg}^{H} {A}_{f g} 〉 = {B}_{f}^{H} ( {I}_{T} ⊗ {A}_{I} {C}_{ff} {A}_{I}^{H} ) {B}_{f} \\ 〈 {Γ}_{f} 〉 = reshape ( 〈 {γ}_{f} 〉 , [ {N}_{g} , K ] )\end{matrix} \qquad [ Equation 17 ]$$

The update of m_{f} and C_{f} in row 9 of [Table 2] may be performed as in [Equation 18] below.

$$\begin{matrix}{m}_{f} = {C}_{f} ( \frac{1}{{σ}_{B}^{2}} {〈 {A}_{fg} 〉}^{H} ( y - 〈 {b}_{f h} 〉 ) + \frac{1}{{σ}_{I}^{2}} {A}_{f}^{H} 〈 u 〉 ) \\ {C}_{f} = {( \frac{1}{{σ}_{B}^{2}} 〈 {A}_{fg}^{H} {A}_{fg} 〉 + \frac{1}{{σ}_{I}^{2}} {A}_{f}^{H} {A}_{f} + 〈 {Γ}_{f} 〉 )}^{- 1}\end{matrix} \qquad [ Equation 18 ]$$

The variables used for updating <γ_{f}> in row 10 of [Table 2] are as shown in [Equation 19] below.

$$\begin{matrix}\overline{a} = a + 1 \\ {\overline{b}}_{f , i} = b + {[ {C}_{f} + {m}_{f} {m}_{f}^{H} ]}_{i , i} ( i = 1 , … , {N}_{g} K )\end{matrix} \qquad [ Equation 19 ]$$

The update of <γ_{f}> in row 10 of [Table 2] may be performed as in [Equation 20] below.

$$〈 {γ}_{f , i} 〉 = \frac{\overline{a}}{{\overline{b}}_{f , i}} ( i = 1 , … , {N}_{g} K ) \qquad [ Equation 20 ]$$

The variables used for updating <u> in row 11 of [Table 2] are as shown in [Equation 21] below.

$$\begin{matrix}〈 {b}_{uf} 〉 = diag ( vec ( Ω ) ) ( {X}^{T} ⊗ {A}_{I} ) {m}_{f} \\ \begin{matrix}{α}_{i} = ( {\hat{z}}_{i}^{lo} - 〈 {b}_{u f , i} 〉 ) / ( {σ}_{I} / \sqrt{2} ) & ( i = 1 , … , NT )\end{matrix} \\ \begin{matrix}{β}_{i} = ( {\hat{z}}_{i}^{u p} - 〈 {b}_{u f , i} 〉 ) / ( {σ}_{I} / \sqrt{2} ) & ( i = 1 , … , NT )\end{matrix}\end{matrix} \qquad [ Equation 21 ]$$

The update of <u> in row 11 of [Table 2] may be performed as in [Equation 22] below.

$$\begin{matrix}〈 Re ( {u}_{i} ) 〉 = Re ( 〈 {b}_{uf , i} 〉 ) - \frac{{σ}_{I}}{2} \cdot \frac{ϕ ( Re ( {β}_{i} ) ) - ϕ ( Re ( {α}_{i} ) )}{Φ ( Re ( {β}_{i} ) ) - Φ ( Re ( {α}_{i} ) )} ( i = 1 , … , NT ) \\ 〈 Im ( {u}_{i} ) 〉 = Im ( 〈 {b}_{uf , i} 〉 ) - \frac{{σ}_{I}}{2} \cdot \frac{ϕ ( Im ( {β}_{i} ) ) - ϕ ( Im ( ( {α}_{i} ) )}{Φ ( Im ( {β}_{i} ) ) - Φ ( Im ( {α}_{i} ) )} ( i = 1 , … , NT )\end{matrix} \qquad [ Equation 22 ]$$

The update operations of rows 5 to 11 of [Table 2] are repeated until a termination condition is satisfied. The termination condition may be defined in various ways, and for example, may include at least one of the following: a difference between the values before and after the update of the variables being less than a threshold, the rate of change of the values due to the update being less than a threshold, and the number of repetitions reaching a threshold number.

FIG. 13 illustrates an example of channel estimation and communication timing according to an embodiment of the present disclosure. FIG. 13 illustrates a timing diagram showing channel estimation and data transmission. Referring to FIG. 13, T_{c} denotes a coherence time, and it is assumed that during a time interval T_{c}, none of the UE-IRS link, the IRS-BS link, and the UE-BS link change enough to affect communication performance. According to the channel estimation technique according to various embodiments, during the previous time interval T, a channel is estimated according to the aforementioned algorithm from reference signals received from the base station and the active elements of the IRS via the uplink, and then during the remaining time interval T_{c}-T, the UEs transmit data to the base station via the uplink using the estimated channel. If the uplink communication and the downlink communication are according to TDD (time division duplex), the channel estimated in the uplink may also be used for communication in the downlink.

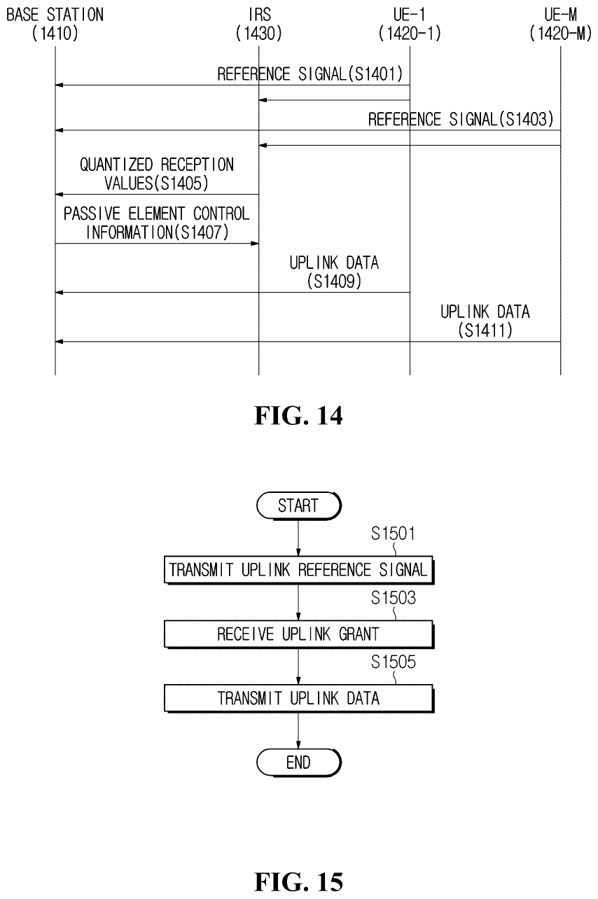

FIG. 14 illustrates an example of an uplink communication procedure according to an embodiment of the present disclosure. FIG. 14 illustrates signal exchange between a base station 1410, a plurality of UEs 1420-1 to 1420-M, and an IRS 1430.

Referring to FIG. 14, in steps S1401 and S1403, each of the plurality of UEs 1420-1 to 1420-M transmits at least one reference signal. The at least one reference signal transmitted from each of the plurality of UEs 1420-1 to 1420-M may be received by each of the base station 1410 and the IRS 1430. Although not illustrated in FIG. 14, prior to transmitting the at least one reference signal, the plurality of UEs 1420-1 to 1420-M may receive configuration information for transmission of the reference signal from the base station 1410.

In step S1405, the IRS 1430 transmits quantized reception values to the base station 1410. Specifically, the IRS 1430 may quantize reception values for reference signals received from plurality of UEs 1420-1 to 1420-M and transmit the quantized result to the base station 1410. Here, the quantized result is transmitted through a separate logical or physical link different from the link through which the reference signals are transmitted. According to an embodiment, the quantized result may be transmitted through a wired link formed between the IRS 1430 and the base station 1410.

In step S1407, the base station 1410 transmits control information for passive elements to the IRS 1430. The control information indicates a reflection coefficient (e.g., a phase coefficient) applied to each of the passive elements included in the IRS 1430. Specifically, the control information may include at least one of an adjustment value of a reflection coefficient, an index indicating a set of reflection coefficients, or values of reflection coefficients to be applied. Accordingly, the IRS 1430 may set the reflection coefficients of the passive elements to match the channel.

Although not illustrated in FIG. 14, an interface establishment procedure between the base station 1410 and the IRS 1430 has been performed in advance, and the base station 1410 and the IRS 1430 may transmit/receive the quantized reception values and the control information through the established interface. According to various embodiments, the interface between the base station 1410 and the IRS 1430 may be established on a direct path between the base station 1410 and the IRS 1430 or on a detour path via another entity.

In steps S1409 and S1410, each of the plurality of UEs 1420-1 to 1420-M transmits uplink data. That is, the base station 1410 may estimate a channel, perform scheduling based on the estimated channel, and provide an uplink grant to the plurality of UEs 1420-1 to 1420-M. The plurality of UEs 1420-1 to 1420-M may transmit data signals using the same time-frequency resource.

In the embodiment described with reference to FIG. 14, the plurality of UEs 1420-1 to 1420-M participate in the procedure. According to one embodiment, each of the plurality of UEs 1420-1 to 1420-M may logically use one transmit antenna. In another embodiment, at least some of the plurality of UEs 1420-1 to 1420-M may utilize a plurality of logical transmit antennas. In this case, a UE utilizing the plurality of logical transmit antennas may perform operations corresponding to one logical transmit antenna for each transmit antenna. In other words, a UE utilizing the plurality of logical transmit antennas may be understood as a group of UEs utilizing one logical transmit antenna.

FIG. 15 illustrates an example of a procedure for transmitting uplink data according to an embodiment of the present disclosure. FIG. 15 illustrates a method of operating a UE.

Referring to FIG. 15, in step S1501, the UE transmits at least one uplink reference signal. The at least one uplink reference signal may include a sounding reference signal (SRS) and may be transmitted through a resource allocated by a base station. That is, prior to transmitting the at least one reference signal, the UE may receive configuration information for transmission of the reference signal from the base station. The configuration information may include at least one of a time-frequency resource, a sequence, and a power allocated for the at least one uplink reference signal.

In step S1503, the UE receives an uplink grant. That is, the UE receives information indicating resources allocated for uplink communication. In other words, the UE receives downlink control information (DCI) for uplink communication. The DCI may further include at least one of modulation and coding scheme (MCS) information or precoding-related information. Here, the precoding-related information is related to precoding determined based on a channel estimated based on at least one uplink reference signal transmitted in step S1501. For example, the precoding-related information may include information for determining a precoder.

In step S1505, the UE transmits uplink data. The UE may transmit uplink data according to the uplink grant. Specifically, the UE may encode and modulate data, perform precoding on modulation symbols, and then transmit the precoded symbols through the allocated resources.

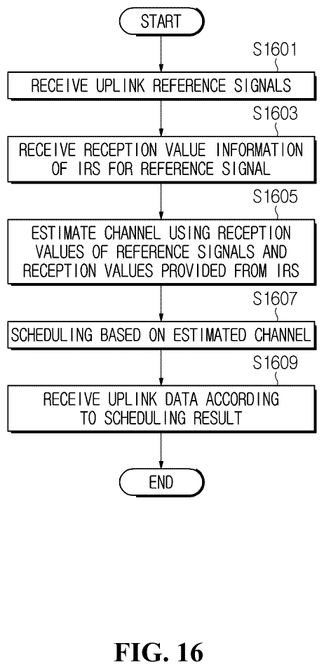

FIG. 16 illustrates an example of a procedure for receiving uplink data according to an embodiment of the present disclosure. FIG. 16 illustrates a method of operating a base station.

Referring to FIG. 16, in step S1601, the base station receives uplink reference signals. The uplink reference signals may include an SRS. The uplink reference signals are transmitted from at least one UE. Prior to receiving the reference signals, the base station may transmit configuration information for transmission of the reference signal from the base station to at least one UE. The configuration information may include at least one of a time-frequency resource, a sequence, or a power allocated for at least one uplink reference signal.

In step S1603, the base station receives reception value information of the IRS for reference signals. The reference signals may be received by the base station as well as the IRS. The base station requires reception values for the reference signals in the IRS to estimate the channel between the IRS and the UEs. Therefore, the IRS may provide reception values for the reference signals to the base station. Here, the received reception value information includes quantized values in the IRS. At this time, the signaling overhead may be adjusted by controlling the level of quantization.

In step S1605, the base station estimates a channel using the reception values of the reference signals and the reception values provided from the IRS. The base station may estimate at least one of the channel between the UEs and the IRS, the channel between the UEs and the base station, and the channel between the IRS and the base station using the reception values at the base station for the reference signals and the reception values at the IRS. According to one embodiment, the base station may estimate the channel by determining a variational inference-based posterior distribution using Bayesian modeling.

In step S1607, the base station performs scheduling based on the estimated channel. The base station may allocate resources to UEs based on the estimated channel, and determine at least one of reflection coefficients applied to precoders of the UEs and elements of the IRS. The base station may perform scheduling by considering the estimated channel, signal characteristics due to reflection of the IRS, combined gain of the reflected signal and the directly received signal, etc. At this time, depending on the size or quality of the channel, the use of the IRS may be optional. That is, scheduling may be performed without using the IRS.

In step S1609, the base station receives uplink data according to the scheduling result. That is, the base station may control the reflection coefficient of the IRS and transmit an uplink grant to the UEs. Accordingly, the base station may receive uplink signals transmitted by the UEs through the channel between the UEs and the base station, and may also receive uplink signals reflected by the IRS.

As described above, the reference signals transmitted by the UEs through the uplink are received by the active element of the IRS and the antenna of the base station. The signals received by the IRS are quantized through a B-bit ADC and then transmitted to the base station through the fronthaul. Thereafter, the base station estimates the channel through the proposed channel estimation algorithm based on the information received from the IRS and the reference signals received from its antenna. Thereafter, when the channel estimation is completed, the base station may adjust the reflection coefficients of the passive element of the IRS to maximize spectral efficiency and receive uplink data from the UEs.

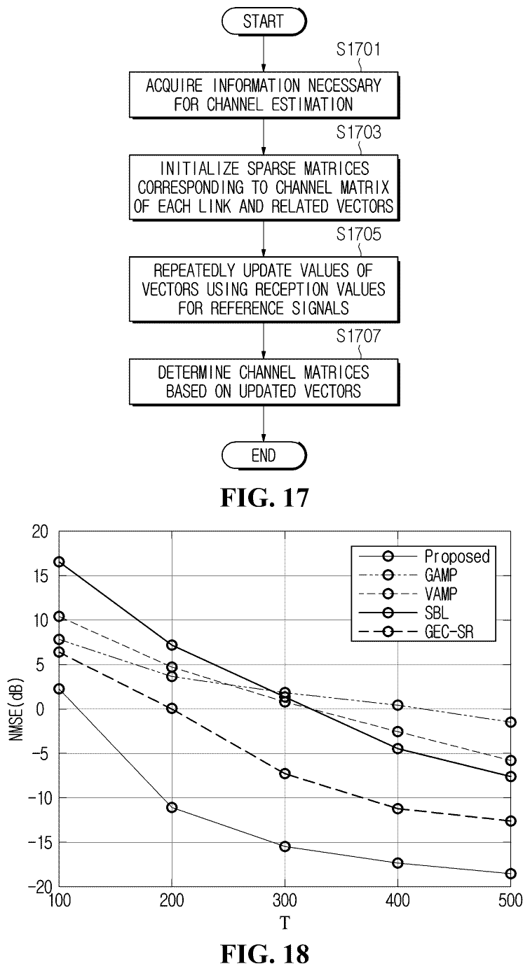

FIG. 17 illustrates an example of a procedure for estimating a channel according to an embodiment of the present disclosure. FIG. 17 illustrates a method of operating a base station.

Referring to FIG. 17, in step S1701, the base station acquires information necessary for channel estimation. The information necessary for channel estimation may include at least one of information about the antenna structure of the base station, information about the structure of the IRS (e.g., number of elements, number of active elements, position of active elements, etc.), information about the number of UEs, or information about noise experienced by the base station and the IRS. To this end, the base station may perform measurement on a reference signal or collect necessary information during an interface establishment procedure with the IRS.

In step S1703, the base station initializes sparse matrices corresponding to the channel matrix of each link and related vectors. The base station treats the sparse matrices corresponding to the channel matrix of each link as probability variables and estimates the channel by determining the mean of the posterior distribution of the probability variables. Accordingly, the base station initializes the vector representing the posterior distribution related to each link to a predefined value.

In step S1705, the base station repeatedly updates the values of the vectors using the reception values for the reference signals. That is, the base station repeatedly updates the mean and covariance of the posterior distribution, thereby converging the posterior distribution related to each link to the estimation result. For example, the posterior distributions may be updated through operations such as [Equation 9] to [Equation 22] derived based on [Equation 8]. The update operation may be repeated until the termination condition is satisfied.

In step S1707, the base station determines channel matrices based on the updated vectors. Here, the channel matrices include at least one of a channel matrix representing the link between the UE and the base station, a channel matrix representing the link between the UE and the IRS, or a channel matrix representing the link between the IRS and the base station.

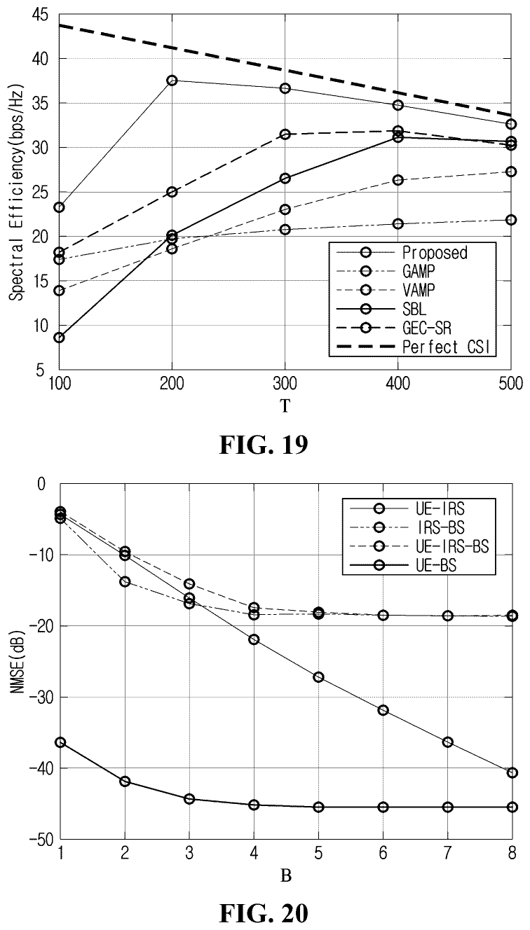

FIG. 18, FIG. 19 and FIG. 20 illustrate the performance of a channel estimation technique according to an embodiment of the present disclosure. FIG. 18, FIG. 19 and FIG. 20 show simulation results for the channel estimation technique proposed in the present disclosure. In the simulation, the base station is set to include M=16 antennas arranged in a ULA (uniform linear array) form, and the IRS is set to include N=8×8=64 elements arranged in a UPA (uniform planar array) form. In addition, in the channel estimation step, Nₐ=4 IRS elements operate as active elements capable of receiving signals, and the remaining Nₚ=60 elements operate as passive elements. In addition, each of the reference signals received from the active elements is quantized through a 4-bit ADC and then transmitted to the base station. In the data communication step, all elements of the IRS operate as passive elements. In addition, in the simulation, it is assumed that K=4 single-antenna UEs participate. The millimeter-wave carrier frequency of the system is f_{c}=28 GHz and the bandwidth is W=80 MHz. The path loss value of the channel is converted into decibels as follows.

$$P L = \{ \begin{matrix}61.4 + 20 {log}_{10} d + ( 0 , {5.8}^{2} ) & for LoS \\ 72 + 29.2 {log}_{10} d + ( 0 , {8.7}^{2} ) & for NLos\end{matrix} \qquad [ Equation 23 ]$$

In [Equation 23], PL denotes path loss, d denotes link distance in meters, and CN( ) denotes a Gaussian distribution function.

In the simulation, the BS and IRS are placed at (0, 0) m and (20, 10) m, and four UEs are placed on a circle with a radius of 5 m centered at (40, 0) m. The UE-IRS and IRS-BS links are assumed to be LoS, and the UE-BS link is assumed to be NLoS. In addition, the Rician K-value of the LoS link is set to 13.2 dB. Also, it is assumed that there are four NLoS paths in all links. The noise figure (NF) of the active elements of the IRS and the BS antenna is 7 dB, and the resulting noise variance is σ_{B}²=σ_{Ihu 2}=W·N₀·NF≈−88 dBm. Here, N₀=−174 dBm/Hz. In the simulation, the channel coherence time T_{c} is set to 1800. In order to evaluate the performance of the proposed algorithm (e.g., the VI-SBL algorithm), FIGS. 18, 19, and 20 show the results of comparison with compressed sensing millimeter-wave channel estimation algorithms that consider the characteristics of passive element-based IRS systems. Specifically, compressed sensing algorithms, GAMP, VAMP, SBL, and GEC-SR algorithms, are applied to the IRS channel estimation problem, and they are compared with the algorithm proposed in the present disclosure. Since the compressed sensing millimeter-wave channel estimation algorithm uses only passive elements, only the UE-IRS-BS link may be estimated, and the UE-IRS link and the IRS-BS link may not be estimated separately. Therefore, FIGS. 18, 19, and 20 mainly compare the NMSE of the UE-IRS-BS link. In the simulation, the UE transmit power in the channel estimation and data transmission steps is 23 dBm.

The results of comparing the UE-IRS-BS link estimation error of the proposed technique with GAMP, VAMP, SBL, and GEC-SR in terms of NMSE are as shown in FIG. 18. For reference, in the comparison algorithms, it is assumed that Nₐ=0 active elements and Nₚ=65 passive elements are used in the IRS. Referring to FIG. 18, it is confirmed that the proposed technique provides relatively accurate channel estimation even in a situation where the pilot overhead is low such as T=200, whereas the other algorithms have relatively accurate channel estimation only in the region of T≥400. The reason why the channel estimation performance of the proposed technique is superior is because the reference signals received from a small number of active elements are optimally utilized. In other words, the proposed technique may provide superior performance because an approximation of the MMSE channel estimation value that minimizes the channel estimation error is obtained.

FIG. 19 shows frequency efficiency in a data transmission step according to a reference signal length. That is, FIG. 19 shows frequency efficiency that may be obtained when the reflection coefficients of the passive elements of the IRS are set based on an estimated channel. Referring to FIG. 19, it is confirmed that the maximum frequency efficiency that the proposed technology may achieve is about 37.5 bps/Hz, while the maximum frequency efficiency that GAMP, VAMP, SBL, and GEC-SR may achieve is about 31 bps/Hz. That is, through the proposed technology, a performance improvement of about 20% in terms of frequency efficiency can be obtained.

FIG. 20 shows the results of expressing the errors of all links estimated by the proposed technology as NMSE when the reference signal length is fixed to T=400. Referring to FIG. 20, in the case of the IRS-BS link and the UE-BS link, almost the same performance as that of B=∞ bits may be obtained by using a B=4-bit ADC. However, it is confirmed that the UE-IRS link estimation error decreases even as the ADC resolution continues to increase, because the UE-IRS link estimation process is directly affected by the ADC resolution. However, in terms of frequency efficiency in actual data communication, it is sufficient to use only a B=4-bit ADC, and the reasons are as follows. In general, the optimal IRS passive element values in the data communication step depend only on the UE-IRS-BS link and the UE-BS link, but according to FIG. 20, sufficient estimation results for the UE-IRS-BS link and the UE-BS link may be obtained even by using only a B=4-bit ADC. Therefore, it can be concluded that maximum performance can be achieved even by using only B=4-bit ADC.

As above, the proposed technique can provide very high channel estimation accuracy because it is an approximate MMSE algorithm that minimizes channel estimation error by using information obtained from the active elements of the IRS. In addition, the proposed technique does not require a complex channel estimation protocol to estimate all links, and enables channel estimation using only a reference signal through the uplink.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving reference signals from at least one user equipment (UE);
estimating a channel based on the reference signals;
performing scheduling for uplink communication;
transmitting an uplink grant to the at least one UE based on a result of scheduling; and
receiving uplink data from the at least one UE according to the uplink grant,
wherein the channel is determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

2. The method of claim 1, wherein the channel comprises first channel between the at least one UE and the base station, second channel between the at least one UE and the IRS and third channel between the IRS and the base station.

3. The method of claim 1, further comprising:
receiving information related to reception values at the active elements of the IRS for the reference signals from the IRS.

4. The method of claim 1, further comprising:
transmitting, to the IRS, information related to reflection coefficients applied to elements of the IRS, determined based on the channel.

5. The method of claim 1, wherein the channel is estimated by determining a variational inference-based posterior distribution using Bayesian modeling.

6. The method of claim 5, wherein the channel is estimated based on at least one of the number and positions of active elements used by the IRS to receive the reference signals, the number of at least one UE or information related to an antenna structure of the base station.

7. The method of claim 5, wherein the channel is estimated by treating sparse matrices corresponding to each of a first channel between the at least one UE and the base station, a second channel between the at least one UE and the IRS, and a third channel between the IRS and the base station as probability variables and determining means of the posterior distribution of the probability variables.

8. A base station comprising:
a transceiver; and
a processor connected to the transceiver,
wherein the processor is configured to:
receive reference signals from at least one user equipment (UE);
estimate a channel based on the reference signals;
perform scheduling for uplink communication;
transmit an uplink grant to the at least one UE based on a result of scheduling; and
receive uplink data from the at least one UE according to the uplink grant,
wherein the channel is determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

9. A communication apparatus comprising:
at least one processor; and
at least one computer memory connected to the at least one processor and configured to store instructions directing operations when executed by the at least one processor,
wherein the operations comprise:
receiving reference signals from at least one user equipment (UE);
estimating a channel based on the reference signals;
performing scheduling for uplink communication;
transmitting an uplink grant to the at least one UE based on a result of scheduling; and
receiving uplink data from the at least one UE according to the uplink grant,
wherein the channel is determined based on reception values at the base station for the reference signals, reception values at the base station for reference signals reflected from an intelligent reflecting surface (IRS) and reception values at active elements of the IRS provided from the IRS through a second link different from a first link through which the reflected reference signals are received.

10. (canceled)
